(19) United States
(12) Patent Application Publication
(10) Pub. No.: US 2008/0071496 A1
(43) Pub. Date: Mar. 20, 2008

(54) METHOD AND APPARATUS FOR MEASURING WALL THICKNESS, OVALITY OF TUBULAR MATERIALS

(75) Inventor: DAVID GLASCOCK, Spring, TX (US)

Correspondence Address: WONG, CABELLO, LUTSCH, RUTHERFORD & BRUCCULERI,;L.L.P., 20333 SH 249, SUITE 600, HOUSTON, TX, 77070, US

(73) Assignee: CUDD PRESSURE CONTROL, INC., HOUSTON, TX (US)

(21) Appl. No.: 11/859,663

(22) Filed: Sep. 21, 2007

Related U.S. Application Data
(63) Continuation-in-part of application No. 11/744,334, filed on May 4, 2007.
Application No. 11/744,334 is a continuation of application No. 11/367,031, filed on Mar. 2, 2006, now Pat. No. 7,231,314.
(60) Provisional application No. 60/657,853, filed on Mar. 2, 2005.

(51) Int. Cl. G01B 15/00

(52) U.S. Cl. 702/155

(57) ABSTRACT

The wall thickness and ovality of a tubular are simultaneously determined. The theoretical radius of a pipe is computed from a measurement of its circumference. An ultrasonic device conventionally used to measure the wall thickness of tubulars is adapted to also measure the maximum and minimum diameters and ovality by equipping or utilizing existing ultrasound inspection device with contact surfaces which contact the tubular at a fixed distance apart and at a known distance from the surface of the ultrasonic transducer. The contact surfaces define a chord of known length on the tubular under test. The mean radius of the tubular may be computed from multiple water path measurements around the circumference relative to a known fixture. The maximum and minimum diameter and ovality are calculated from the measured differences in distance from the surface of the tubular to the ultrasonic transducer and the theoretical circle. Wall thickness and ovality may be correlated relative to position by using the same apparatus for both measurements.

### CROSS-REFERENCES TO RELATED APPLICATIONS

This application is a continuation-in-part of application Ser. No. 11/744,344 filed May 4, 2007, which is a continuation of application Ser. No. 11/367,031 filed Mar. 2, 2006, which claims priority to a provisional patent application by the same inventor, entitled: “Method and Apparatus for Measuring Wall Thickness, Ovality of Tubular Materials,” Ser. No. 60/657,853, filed on Mar. 2, 2005. The disclosures of application Ser. Nos. 11/367,031 and 60/657,853 are hereby incorporated by reference in their entirety.

### BACKGROUND OF THE INVENTION

1. Field of the Invention

This invention relates to methods and devices for measuring the dimensions and mechanical properties of pipes, tubes and the like. More particularly, it relates to an ultrasonic device which measures the wall thickness and the maximum and minimum diameter using an ultrasonic probe, instrumentation and a triangulated fixture. It includes subsequent calculations of the wall thickness eccentricity and the associated ovality [roundness] of the pipe and tube relative to position.

2. Description of the Related Art

A perfect circle is the most desirable cross section for tubulars. It provides the greatest strength—i.e., resistance to both internal and external pressure—of any known shape. Moreover, a perfectly [or near perfect] circular cross section facilitates the joining of tubulars to fittings, additional sections of tubular material and the like.

Wall thickness and wall integrity are also important parameters of tubular materials. In general, thicker walls and walls that are free from defects in the material forming the wall provide greater strength and hence greater safety. The combination of the wall thickness and associated ovality data along the length of the tubular is necessary calculations to determine collapse and burst pressures.

In the past, wall thickness and ovality have been measured separately, using two different measuring devices. Most commonly, wall thickness has been measured using an ultrasonic instrument with a transducer coupled to the tubular under test with a liquid [water] interface. The time for the ultrasonic waves to reflect from both the external and internal surfaces of the tubular is converted into distance (wall thickness) using the measured the time and the known velocity of the sound wave in the material.

Diameter is presently measured using a mechanical device such as a micrometer, an optical device such as a laser or camera or multiple ultrasound transducers or an array mounted to a known diameter fixture reference which surrounds the tubular.

An oval may be considered a flattened circle or an ellipse. An ellipse is a closed plane curve generated by a point moving in such a way that the sums of its distances from two fixed points (foci) is a constant. The length from one side of an ellipse to the other which passes through both foci may be considered its major diameter. A line perpendicular to the major diameter and passing through the ellipse at its widest part may be considered its minor diameter. Ovality may be defined as being the major diameter minus minor diameter. A perfect circle has an ovality of zero. Alternatively, pipe ovality may be expressed as a percentage:
% Pipe Ovality=100×(Max. Diameter−Min. Diameter)/Mean Diameter

There are many useful applications for applying diameter, ovality, wall thickness and eccentricity determinations to pipe and tubes. Engineers use the combination of pipe wall thickness and ovality for their burst and collapse calculations The process of bending straight pipe to make it into a coil distorts its original, circular cross-section into an oval and leaves it with a permanent curvature. Codes prohibit installing pipe that is more than 5% oval. The diameter and ovality (shape) of pipe ends can greatly complicate aligning the ends for butt-welding the pipes together. Drill pipe is subjected to both outside and inside wear due to the environment Codes govern the dimensional properties of drill pipe.

### SUMMARY OF THE INVENTION

The present invention comprises a method and apparatus for measuring wall thickness and ovality of tubular materials. The invention also provides a method for adapting an ultrasonic device used for measuring the wall thickness on a pipe or tube, to also measure the maximum and minimum diameter and ovality. The transducer water path is measured using a known triangulated fixture for positioning the transducer relative to the surface of the pipe or tube and the mean radius and center is computed. The mean radius, arc height (H) and ½ chord length (C) are related by the derived equation; R.dbd.(C.sup.2/2H)+H/2. Diameter (and associated ovality) may be calculated by applying the measured arc height changes to the mean radius and calculating actual pipe radius at different positions around the circumference of the pipe or tube.

### BRIEF DESCRIPTION OF THE DRAWING FIGURE

FIG. 1 is a cross sectional view of a tubular in contact with an ultrasonic measuring device.

The dimensions of the triangulated fixture (including height) are fixed, thus any change in the measured water path results in a corresponding opposing increase or decrease in the chord height (H). From the above diagram the following relationship applies; H.dbd.R-A R--H=square root (R.sup.2--C.sup.2) And further simplified R.dbd.C.sup.2/2H+H/2 The preferred fixture contact points subtend and arc angle from 90 to 180 degrees.

### DETAILED DESCRIPTION

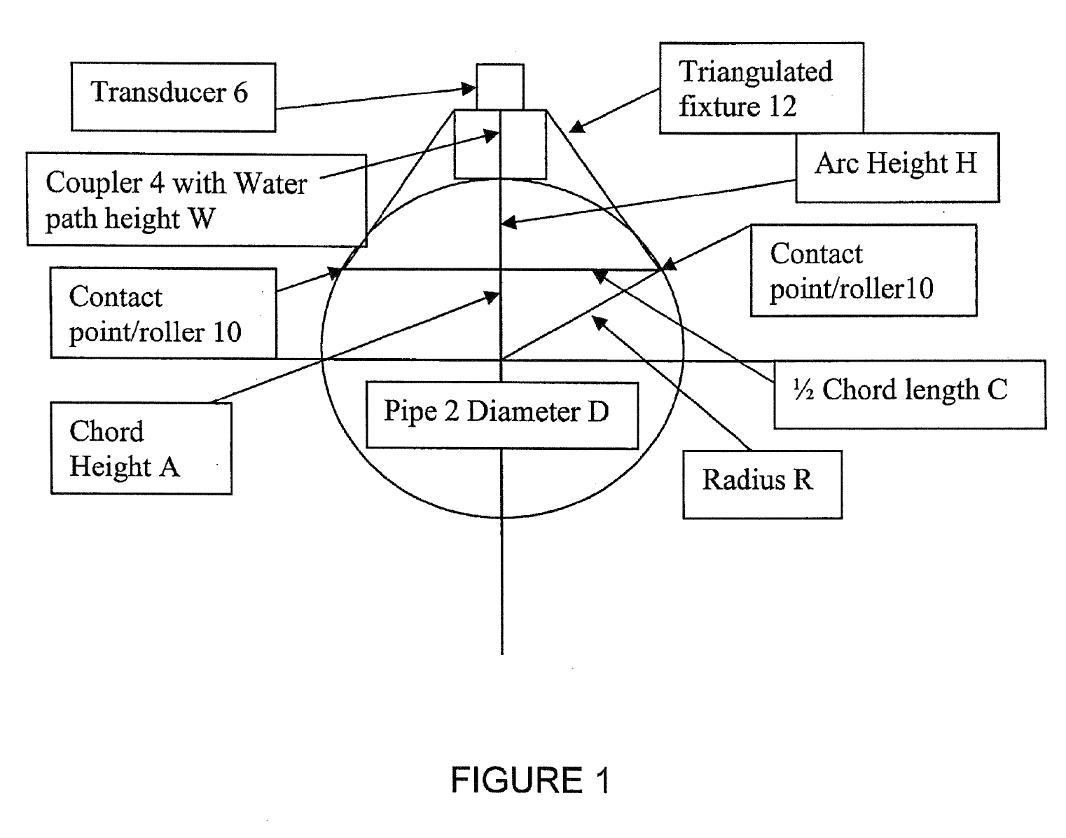

Referring now to FIG. 1, a tubular 2 of diameter D is shown in contact with measuring device 12 comprised of ultrasonic transducer 6 and coupler 4 which may be filled with a fluid 8 which may, in some embodiments, be water.

Coupler or shoe 4 may include contact rollers 10 for contacting the external surface of pipe 2. The height E (H+W) from the ultrasonic transducer 6 and a chord connecting the contact points of rollers 10 is determined by manufacture and may be measured.

In certain embodiments, fixture 12 is not equipped with rollers 10. Nevertheless, the height E from the chord joining the points of contact and the transducer is fixed and may be measured with a high degree of accuracy.

It will be appreciated by those skilled in the art that the water path distance W between transducer 6 and the external surface of pipe 2 may be measured electronically by measuring device 12.

The mean radius of pipe 2 is calculated using the average arc heights (H) for one revolution, the given (measured) fixture transducer to contact point height (HW), and the equation: R.dbd.C.sup.2/2H+H/2

The mean radius of the pipe describes the theoretical pipe center and circumference to which the ovality has been applied. The diameter and circumference may be calculated from the equations of a circle. Alternately the circumference may be measured and the theoretical pipe center and radius calculated.

The theoretical circle describes the real pipe circumference and applicable center for a circle, for an oval shape it is assumed that the change in (A) relative to the major and minor axis will be negated and the difference between the measured maximum and minimum arc height above that of the theoretical circle center will provide for the approximate maximum and minimum diameter of the pipe. The ovality can be calculated using the difference between the maximum and minimum diameter per pipe revolution.

It is known in the industry that the same ultrasonic probe that is used to measure the water path (W) can also be used to measure the wall thickness at the same location. Eccentricity may be calculated using the variation in wall thickness per revolution of the pipe.

Since maximum and minimum diameter (ovality) may be determined using substantially the same apparatus as that used to measure wall thickness and eccentricity they can be correlated relative to position.

A paper by D. Moore entitled “Design Considerations in Multiprobe Roundness Measurement” (J. Phys. E: Sci. Instrum. 22 (1989) pp. 339-343) examines current practice in the multiprobe method of roundness measurement and derives design strategies for improved measurement accuracy and reliability. The multiprobe method is said to eliminate variable centering errors by combining displacement measurements made simultaneously at several points about the periphery of the workpiece. The disclosure of this paper is hereby incorporated by reference in its entirety.

In many circumstances, the pipe under examination is not a circle and an ellipse may be the more accurate model for determining the shape. By measuring the perimeter of the pipe and assuming a ratio for a and b (the major axis and minor axis), a set of H values can be calculated. Actual a and b values are then identified by finding the calculated H values that best fit the measured H values.

To identify a set of H values for an assumed a to b ratio, start with the general equation for an ellipse:

$$\frac{{x}^{2}}{{a}^{2}} + \frac{{y}^{2}}{{b}^{2}} = 1$$

And the length of the perimeter of the ellipse can be related to a and b by the approximation series

$$\frac{P}{2 Πa} \approx 1 - 1 / 4 {e}^{2} - \frac{3}{64} {e}^{4} - \frac{5}{256} {e}^{6} - \frac{175}{16384} {e}^{8} - \frac{441}{65536} {e}^{10} …$$

Where e equals:

$$\sqrt{1 - \frac{{b}^{2}}{{a}^{2}}}$$

With the equation for an assumed ellipse completed, chord heights can be calculated. The first step to calculate a given chord height is to determine the end points of the chord. This is most easily accomplished by setting one terminus of the chord at (a, 0) or (0, b). Using the terminus (0, b) with known chord length C leads to the equation
(x−0)²+(y−b)²=C²
which reduces to
x²+y²−2by+b²=c²

Substituting a²−(a²/b²)y² (from the general formula for an ellipse) for X², results in the final equation

$$( 1 - \frac{{a}^{2}}{{b}^{2}} ) {y}^{2} - 2 by + {a}^{2} + {b}^{2} - {c}^{2} = 0$$

Which can be solved for Y. This Y value is used with the equation of the ellipse to solve back for X.

Those of skill in the art will appreciate that from these two termini, the slope and midpoint of the chord can be determined. The chord height, H, will be the distance from the midpoint of the chord to the ellipse along a line perpendicular to the chord.

Determining the paired endpoints of chords that do not end at (a, 0) or (0, b) may be accomplished mathematically through solution of a quartic equation dependent upon a, b, and a defined first endpoint. However, the set chords may be easier to determine using iteration. One endpoint on the ellipse is chosen and the distance between this endpoint and a second point on the ellipse is determined. If the distance does not equal the defined chord length, a third point is chosen. The third point will be closer to the defined endpoint if the chord length is less than the calculated distance and further if the chord length is greater than the calculated distance. This process is repeated until the other endpoint is identified by its distance from the defined endpoint (i.e., the point along the ellipse exactly one chord length from the originally defined endpoint).

Those of skill in the art will appreciate that the iteration may be made more efficient by choosing the endpoint and second point in relation to a previously defined chord. For example, let a known chord have endpoints (X₁, Y₁) and (X_{N}, Y_{N}) and length C. to determine the second chord, set X₂ at X₁+0.001 and calculate Y₂ from the equation of the ellipse. (X₂, Y₂) is one endpoint of the second chord. Set X_{N+1} to X_{N}+0.001 and calculate Y_{N+1}. Unless the ellipse is a circle, the distance from (X₂, Y₂) to (X_{N+1}, Y_{N+1}) will not equal C. However, (X_{N+1}, Y_{N+1}) should be reasonably close to the second endpoint and its selection for the first iteration should reduce the total iterations needed to determine the other endpoint of the chord terminating at (X₂, Y₂).

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method for measuring the maximum and minimum diameter and ovality of a tubular comprising: calculating the circumference of the tubular; calculating the mean radius of a circle having the measured circumference; contacting the surface of the tubular at two points in a plane substantially perpendicular to the major axis of the tubular; measuring the distance from the surface of the tubular at a point half way between the two points of contact to the ultrasound transducer at a known distance from a line connecting the two points of contact; using the mean radius to calculate the theoretical pipe center and circumference; calculating the arc height of the tubular by adding or subtracting the water path measurement to a fixed distance defined by the fixture; calculating the maximum and minimum diameters of the pipe relative to the theoretical mean radius and center; calculate the ovality of the tubular by calculating the difference between the maximum and minimum diameters per revolution; and correlating ovality and wall thickness simultaneously using essentially the same apparatus and ultrasonic probe.
